(19) United States
(12) Patent Application Publication
(10) Pub. No.: US 2002/0130211 A1
(43) Pub. Date: Sep. 19, 2002

(54) Holding device for paper towel and napkin holder

(75) Inventor: Helen E.G. Kerr, Toronto (CA)

Correspondence Address: MARK KUSNER, Highland Place, Suite 310, 6151 Wilson Mills Road, Highland Heights, OH, 44143, US

(73) Assignee: Browne & Co.Ltd.

(21) Appl. No.: 10/002,951

(22) Filed: Nov. 15, 2001

(51) Int. Cl. B65H 23/08; B65H 16/04; A47J 47/16

(52) U.S. Cl. 242/422.5; 242/597.7; 248/127

(57) ABSTRACT

A holding device such as a paper napkin or paper towel holder for manual dispensing paper sheets while restraining a stack of napkins or a roll of towels rotating about a vertical axis and for restraining the roll from moving or unwinding when at rest. The restraint arm has a proximal end pivotally mounted to the base and a distal end engaging the outer layer of the stack or roll. Preferably, the distal end of the arm engages a middle portion of the outer layer of the roll and includes a curved contact pad.

### TECHNICAL FIELD

The invention relates to a paper sheet holder for manual dispensing of a stack of paper napkins or a roll of towels rotating about a vertical column, using a pivotally mounted weighted arm extending from the base for restraining the top napkin and free end of the roll from unwinding when at rest.

### BACKGROUND OF THE ART

The prior art provides many alternative holders for dispensing napkins and paper towels. For napkins many devices comprise a box container and for paper towels devices often include a pin or trunion that engages the central hollow core of the roll and enables rotation vertically or horizontally. A box container for napkins usually obscures the view of the user who does not realize the dispenser is approaching an empty state until the last napkin is removed. The boxes also wrinkle corners and deform the napkins which impairs their proper use.

Of particular interest to the present invention are those prior art holding devices that utilize a arm biased to retain the napkins or paper towel roll. Paper roll dispensers with a base to rest on a supporting surface and which orient the roll in a vertical dispensing position often suffer from the disadvantage that the vertically oriented roll unwinds under the force of gravity or is unwound by adjacent air movements.

U.S. Pat. No. 6,012,605 to Miloscia provides a vertical roll dispenser with a base and an exterior arm to restrict the unwinding of the exterior layer of the roll. The arm reaches from the base parallel to the side of the roll, over the top surface of the roll and includes a sphere at the end of the arm to engage the core of the roll and permit it to be rotated about a vertical axis. In order to replace the roll, the arm with sphere must be rotated and a new roll positioned on base.

Another vertical paper towel holder is shown in U.S. Pat. No. 5,763,984 to Day, which includes a base having an annular slot into which a slit tube is positioned. The vertically positioned roll fits within the tube and the free end is dispensed through the vertical slot.

Further, U.S. Pat. No. 4,771,966 to Anderson shows a horizontally oriented paper towel holder with a weighted roller that restrains the free end of the towel from movement due to air currents or other causes of unintentional unrolling. The disadvantage of the Anderson system is that it relies on a horizontal orientation since the force of gravity is used to restrain the free end of the towel with the roller.

The prior art vertically oriented dispenser also suffer from disadvantages. For example, the Miloscia dispenser restrains the free edge of the roll best when a large full roll is placed in the dispenser. However, the more towels that are dispensed the smaller the roll gets and the less restraining action there is by the stationary vertical portion of the arm. In a like manner, the vertical towel holder in Day is adequately restrained when it is relatively large, but as the diameter of the roll decreases when it is dispensed, the roll can rattle around inside of the hollow slit tube. As a result, the towels may be unintentionally oriented such that they rip off in the wrong position and the disturbance from the roll rattling during dispensing is annoying.

U.S. Pat. No. 5,692,639 to Lahaussois et al. shows a vertical dispensing holder with an externally weighted string to restrain the free edge of the roll. A disadvantage of this system is that it must be suspended from a hook and cannot be positioned on a flat tabletop surface for dispensing.

Therefore, although many prior art dispensers attempt to provide a vertical orientation for the roll and attempt to restrain the free edge of the roll from unintentional unrolling, all suffer from some major disadvantage, particularly failure to position the roll on a flat table top surface, failure to adequately restrain the free edge of the roll regardless of the amount of paper towels remaining on the roll, and failure to provide a relatively simple device that can be used without mounting to a wall or suspending from a hook.

It is an object of the invention therefore to provide a simple paper towel holder for dispensing towels rotatably about a vertical axis where the free edge of the towel is adequately restrained from unrolling unintentionally regardless of the amount of towels remaining on the roll.

It is a further object of the invention to provide a paper towel holder that ensures adequate restraint of the towel while requiring no complex mechanism to insert replacement rolls.

It is a further object of the invention to think outside of the box by providing a napkin dispenser that does not obscure the user's view and does not deform napkins within a conventional box dispenser.

Further objects of the invention will be apparent from review of the disclosure, drawings and description of the invention below.

### DISCLOSURE OF THE INVENTION

A holding device such as a paper napkin or paper towel holder for manual dispensing paper sheets while restraining a stack of napkins or a roll of towels rotating about a vertical axis and for restraining the roll from moving or unwinding when at rest. The restraint arm has a proximal end pivotally mounted to the base and a distal end engaging the outer layer of the stack or roll. Preferably, the distal end of the arm engages a middle portion of the outer layer of the roll and includes a curved contact pad.

Further advantages of the invention will be apparent from the following detailed description and accompanying drawings.

### DESCRIPTION OF THE DRAWING

In order that the invention may be readily understood, two embodiments of the invention are illustrated by way of example in the accompanying drawing.

FIG. 1 is an exploded perspective view of the first embodiment being a paper towel holder showing (starting at the bottom and moving clockwise) pedestal base, column, cap, pivoting arm and weighted pad.

FIG. 2 is a like assembled perspective view of the first embodiment showing restraint of the free end of a full roll (in outline) with the pivoting arm and weighted pad.

FIG. 3 is a top plan view of the first embodiment.

FIG. 4 is a side elevation view of the first embodiment showing the pivot arm.

FIG. 5 is a front elevation view of the first embodiment showing the inward pivoting of the arm to accommodate depletion of the roll as it is dispensed.

FIG. 6 is a radial sectional view through the pedestal of the first embodiment.

FIG. 7 is a detail elevation view of the cap of the first embodiment.

FIG. 8 is a bottom view of the cap.

FIG. 9 is a perspective view of the cap.

FIG. 10 is a perspective view of a second embodiment of the invention being a napkin holder showing the base with pivoting weighted restraint arm resting on the top napkin of the stack.

FIG. 11 is a like perspective view of the second embodiment with stack of paper napkins removed to show the complete pivoting of the weighted straint arm and the rubber grips upwardly extending from the top surface of the base.

FIG. 12 is an exploded perspective view of the second embodiment showing the base with rubber inserts removed.

FIGS. 13, 14 and 15 are top, side and bottom views of the second embodiment respectively.

FIG. 16 is a vertical sectional view through the base of the second embodiment showing the assembly of rubber inserts to the formed sheet metal shell of the base.

Further details of the invention and its advantages will be apparent from the detailed description included below.

### DETAILED DESCRIPTION OF PREFERRED EMBODIMENTS

FIG. 1 illustrates an exploded perspective view of the first embodiment paper towel holder showing a pedestal base 1, a vertical column 2, a removable cap 3, a pivoting restraint arm 4 and a weighted contact pad 5.

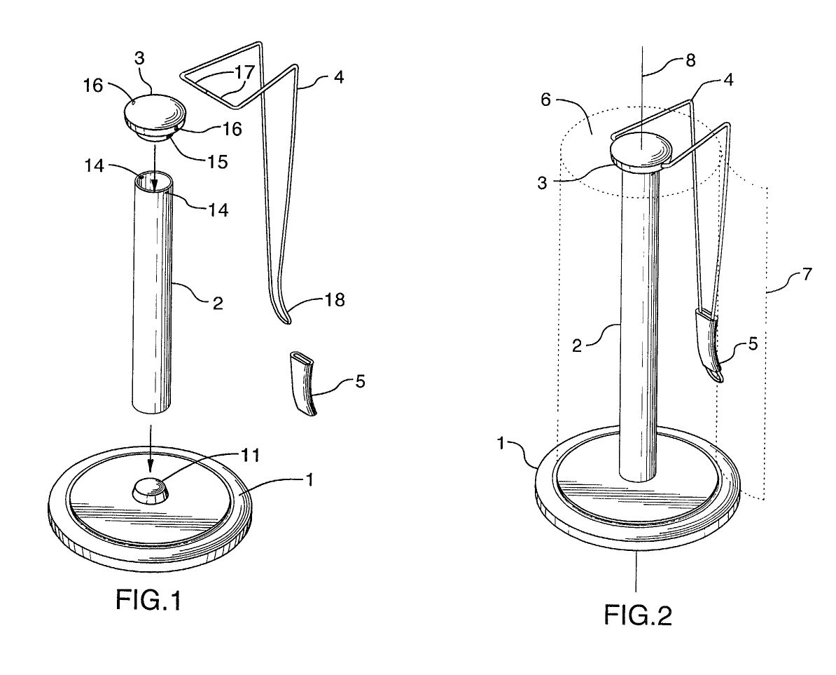

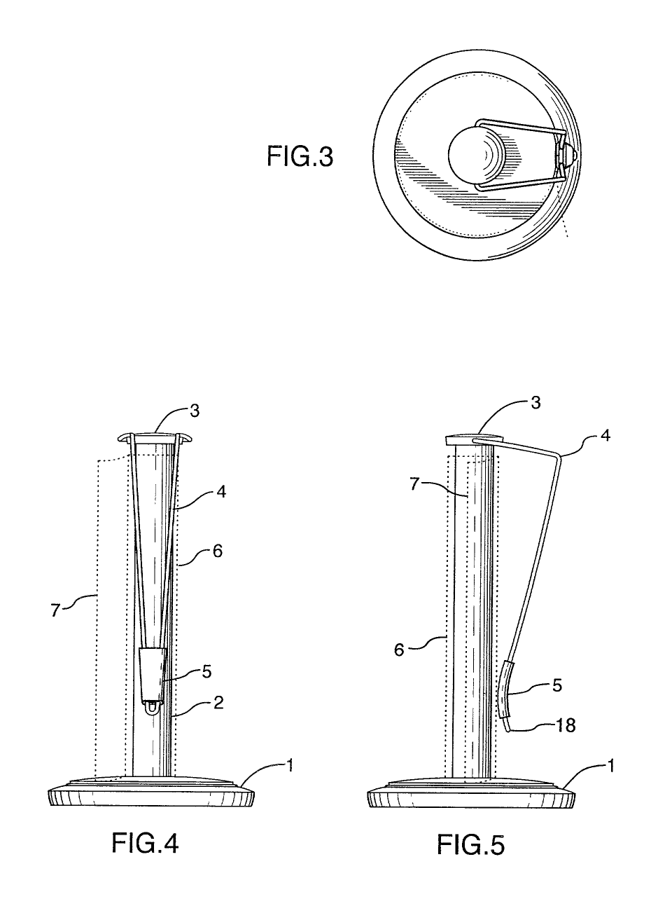

FIG. 2 shows the assembled paper towel holder with restraint arm 4 positioned to restrain the outer cylindrical layer of the roll 6 where the free end 7 is restrained from unrolling under gravity or air movements in an uncontrolled manner.

As shown in FIG. 2, the paper towel holder provides for manual dispensing of the roll 6 of towels rotating about a vertical axis 8, in a manner that restrains the free end 7 of the roll 6 from unwinding. The roll 6 has a tubular core with a spirally wound sheet of paper towels, an outer cylindrical layer terminating in a free end 7 for manual dispensing.

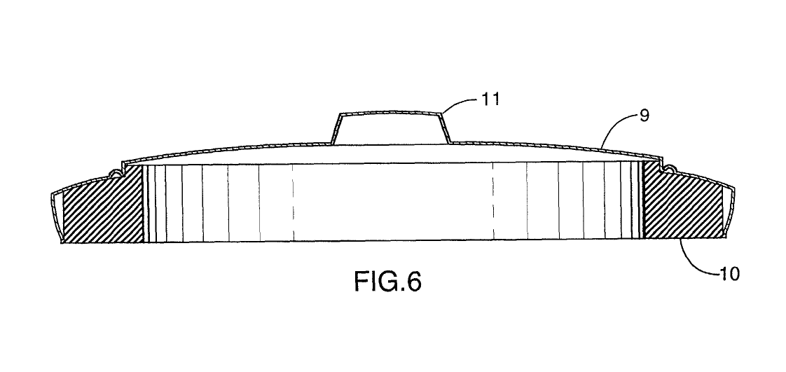

The pedestal 6, as shown in FIG. 6, sectional view, can include a spun or stamped sheet metal shell 9 with an upwardly domed top surface. In order to provide sufficient weight to resist overturning and provide slip resistance, a relatively heavy annular insert 10, comprising a resilient rubber ring 10, can be easily molded and inserted into the sheet metal shell 9. The domed top surface reduces the degree of friction between the rotating roll 6 and the shell 9 as well as providing an aesthetically pleasing appearance.

The column 2 preferably comprises a hollow tube that is fitted over a boss 11 in the sheet metal shell 9 and can be secured with conventional means such as brazing or with rivets for example.

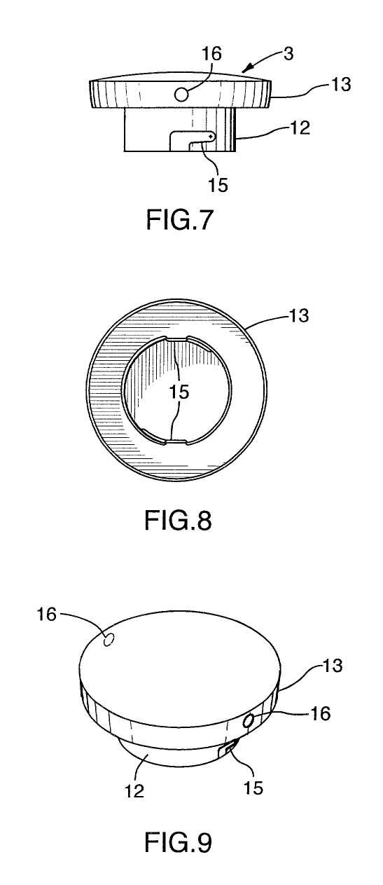

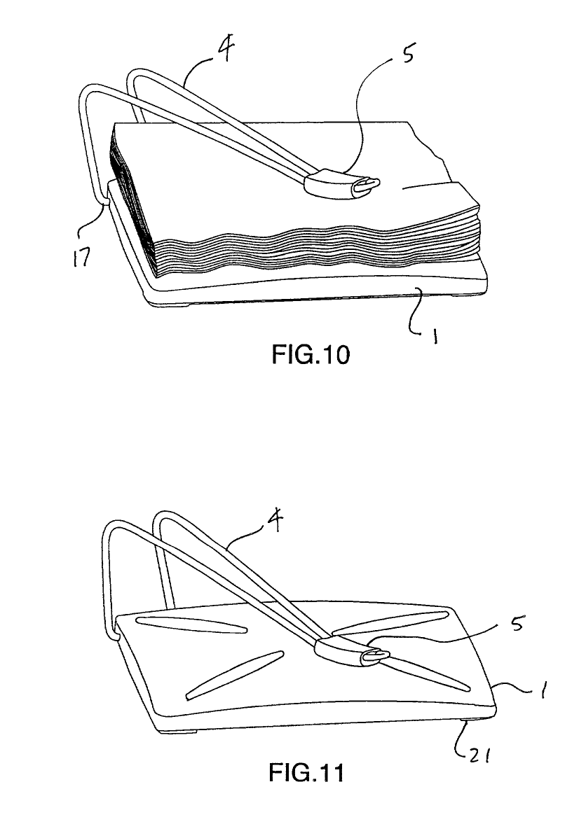

The column's top end includes the removable cap 3, details of which are shown in FIGS. 7, 8 and 9. The cap 3 includes a lower plug portion 12, as shown in FIG. 1 and FIG. 2, which is inserted into the top end of the tube 2. The lower plug portion 12 is releasably engaged on an interior surface of the column tube 2 with interlocking ridges 14 extending inwardly from the top end of the interior tube 2 and L-shaped grooves 15 which are stamped into the side surfaces of the cap plug portion 12 to form a bayonet type interlocking system. As it is shown in FIGS. 2, 4 and 5, the rim portion 13 of the cap 3 serves to vertically restrain the roll 6 as well as to provide sockets 16 into which the coaxial hinge ends 17 of the wire loop restraining arm 4 are pivotally engaged.

therefore, the proximal end of the restraint arm 4 includes the hinge ends 17 and the distal end 18 swings under the force of gravity to engage a middle portion of the outer layer of the roll 6. The contact pad 5 serves to distribute the weight across the bearing surface and provides some visual appeal as well. As best seen in FIG. 5, the arm 4 has a curved profile at the distal end 18 as does the contact pad 5 in a vertical plane through the axis 8. The curved profile seen in FIG. 5 ensures that whatever amount of towels are left remaining on the roll 6, the towels are not subjected to a sharp edge or point contact that may puncture or tear the paper towels. The smooth curved surface of the contact pad 5 therefore prevents unintentional tearing or puncturing damage to the towels while retaining the free edge 7 from unintentionally unrolling. Further, the distal arm 18 can include additional weight to increase the restraining action. In the preferred embodiment illustrated, the contact pad 5 comprises a bent metal sheet such that the weighting function and the smooth retention function are served by a single component 5.

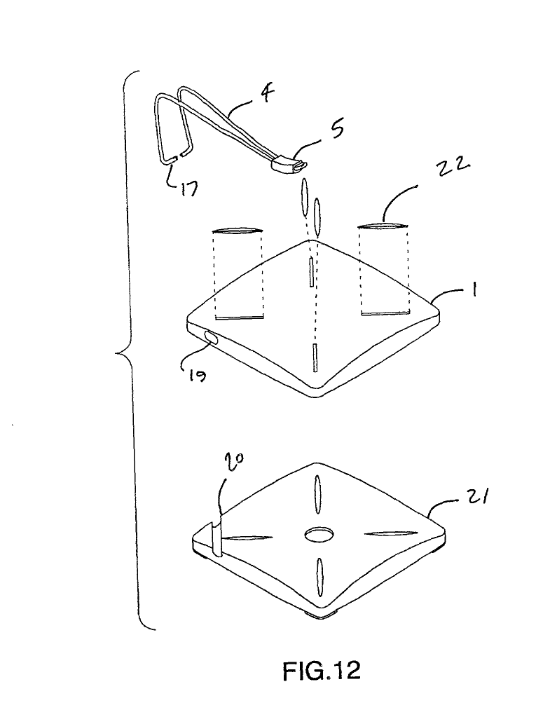

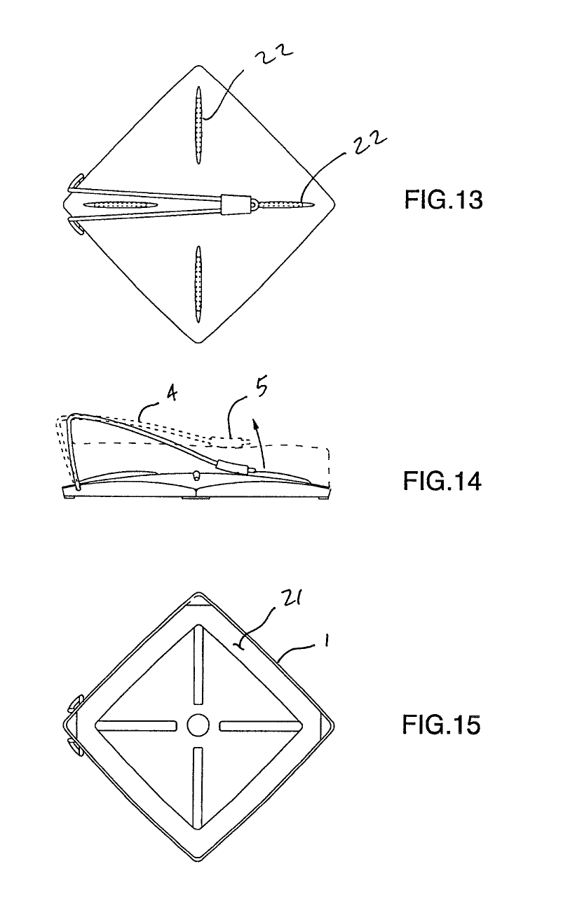

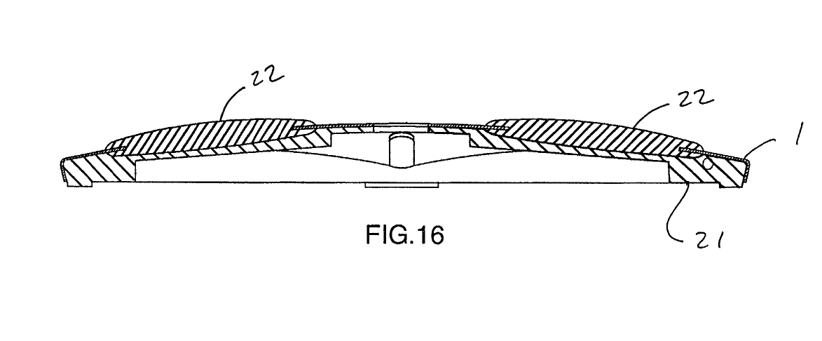

FIGS. 10 through 16 illustrate a second embodiment of the invention, configured to dispense paper sheets in a vertical stack. It will be understood as well that accordion folded sheets and other conventional arrangements of paper sheets may be dispensed in a similar manner. With reference to FIGS. 10 and 11, the base 1 remains in a horizontal plane and the restraint arm 4 including the weighted contact pad 5 is pivotally mounted to a side of the base with the hinge end 17 extending through a corner of the square base 1 as illustrated. The exploded view of FIG. 12 shows the restraint arm 4 with hinge end that is secured in socket 19 in the sheet metal base and extends through a groove 20 in the flexible rubber insert 21. In order to restrain the stack of napkins from sliding on the top surface 1, four non-slip rubber pads 22 are retained within slits in the top surface of the base 1 as best shown in the detailed sectional view of FIG. 16.

Although the above description relates to a specific preferred embodiment as presently contemplated by the inventor, it will be understood that the invention in its broad aspect includes mechanical and functional equivalents of the elements described herein.

I Claim:

1. A holding device for manual dispensing of paper sheets and for restraining the sheets at rest, the device comprising:
a base having a support surface adapted to support a plurality of individual sheets disposed in a dispensing configuration with an outer sheet exposed; and
a restraint arm having: a proximal end pivotally mounted to the base for rotation about a horizontal axis; and a distal end with a weight gravitationally biased for motion within a vertical plane to retain the exposed outer sheet.

2. A holding device according to claim 1 wherein the paper sheets comprise a spirally wound roll of sheets defined between transverse spaced apart rows of perforations, the dispensing configuration defined wherein roll rotates about a vertical axis, wherein the base comprises:
a pedestal;
an elongate vertical column with a top end, a bottom end and adapted to support the roll for rotation about the vertical axis, the bottom end mounted to the pedestal, the top end including a removable cap;
and wherein:
the proximal end of the restraint arm is pivotally mounted to the cap.

3. A holding device according to claim 1 wherein the distal end of the arm engages a middle portion of the outer sheet of the roll.

4. A holding device according to claim 1 wherein the column comprises a hollow tube and the cap has a plug portion slidably releasably engaging an interior surface of the top end of the column tube.

5. A holding device according to claim 4 wherein the plug portion and top end interior surface of the column include interlocking ridges and grooves.

6. A holding device according to claim 5 wherein the cap includes a rim portion extending outwardly from the plug portion.

7. A holding device according to claim 1 wherein the dispensing configuration is defined wherein separate paper sheets are disposed in a vertical stack,
wherein the proximal end of the restraint arm is pivotally mounted to a side of the base.

8. A holding device according to claim 1 wherein the distal end of the arm includes a contact pad.

9. A holding device according to claim 1 wherein the distal end of the arm has a curved profile in said vertical plane.

10. A holding device according to claim 1 wherein the arm comprises a wire loop having opposing coaxial hinge ends engaging sockets in the base.

11. A paper towel holder according to claim 1 wherein the base includes a resilient rubber ring.
